(19) United States
(12) Patent Application Publication
(10) Pub. No.: US 2006/0204151 A1
(43) Pub. Date: Sep. 14, 2006

(54) Lubrication device for linear slide guide

(76) Inventors: Chin-Pei Wang, Taichung (TW); Yun-Yi Lin, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/073,645

(22) Filed: Mar. 8, 2005

(51) Int. Cl. F16C 33/10

(52) U.S. Cl. 384/13; 384/45

(57) ABSTRACT

A lubrication device for linear slide guide, comprising of an end cover made up of resin and a cover plate made up of polymer elastomer wherein the cover plate is closely installed in the placement space of the end cover, meanwhile, the buffer part of the cover plate can be placed in the upward U-turning part and the downward U-turning part on two sides of the end cover to form a complete sealed body, therefore, the flowing channel of the end cover and the flowing space of the cover plate can form a continuous flowing channel so that when lubricant enters the side lubricant hole, the flowing space can evenly distribute the lubricant and let the lubricant enter the lubricant hole through lubricant channel to lubricate rolling component and sliding rail.

### BACKGROUND OF THE INVENTION

1. Field of the Invention

This invention relates to a lubrication device for linear slide guide, it specifically relates to a lubrication device for linear slide guide, which can seal the lubricant and further distribute the lubricant evenly among all the rolling devices for lubrication.

2. Description of the Prior Art

The main purpose and function of a lubrication device for the linear slide guide is to effectively introduce lubricant into rotating part to lubricate the rolling parts in operation, therefore, through the lubrication on the rolling parts, the running smoothness and lifetime of the linear slide guide can be enhanced.

Nevertheless, in the normal design, direct or indirect lubrication is done by using the component on the end of the sliding block, for more details on the prior art lubrication device for linear slide guide, please refer to the followings:

Prior art 1, please refer to the design in U.S. Pat. No. 5,399,023 patent, this is as shown in FIG. 7, it is a lubricant scraping piece 6 having lubricant channel 61, a sponge 62 for controlling the lubricant quantity and a lubricant outflow hole 63 for the outflow of the lubricant are installed on the end of the lubricant channel 61, respectively.

The lubricant channel 61 is installed above the lubricant scraping piece 6 so that the lubricant channel 61 above lubricant channel scraping piece 6 can have very good sealing, therefore, when used in the centralized piping system, it can slightly reduces the leaking chance of the lubricant flowing in the lubricant channel 61, but, there are too many accessories in the above structure, its assembly is thus more complicated and its cost is higher.

Prior art 2, please refer to the design in U.S. Pat. No. DE4,424,795 patent, this is as shown in FIGS. 8 and 9, it is a linear slide guide set 7 having a sliding block main body 8 and a sliding rail 9, a directional backflow space 81 is installed in the sliding block main body 8, the directional backflow space 81 is further installed with more than one rolling components 82, meanwhile, a lubricant nipple 83 is further installed in the sliding block main body 8, the lubricant nipple 83 is connected to a lubricant channel 84 so that the lubricant fed through lubricant nipple 83 can lubricate all the rolling components 82.

Nevertheless, although the lubricant passes through the lubricant nipple 83 can lubricate the rolling component 82 evenly, the sealing of the lubricant channel 84 comes from the sealing due to the contact between the sliding rail 9 and the sliding block main body 8. However, for this method, in using centralized piping system, the lubricant will leak because of too high in pressure.

We know that the above prior art lubrication device for linear slide guide still can not improve the leaking phenomenon, assembling convenience and the reduction of noise, etc., it is thus needed to be improved.

The inventor of the current invention has spent great efforts on improving the problems associated with the prior art lubrication device for guiding rail, and finally come out a lubrication device for guiding rail of the current invention.

### SUMMARY OF THE INVENTION

The main purpose of the current invention is to provide a lubrication device for linear slide guide wherein the cover plate is made up of polymer elastomer and the end cover is made up of metal or resin, moreover, there is somehow dimensional interference, therefore, when the cover plate is placed in the end cover, the cover plate can closely touch the inside of the end cover, this can effectively enhance the sealing property of the flowing space.

Another purpose of the current invention is to provide a cover plate to be closely touched and connected to the end of the end cover, it makes the lubricant channel of the end cover and the flowing space of the cover plate form a continuous flowing channel and a complete sealing body lubrication device for the linear slide guide.

Yet another purpose of the current invention is to provide a cover plate of lubrication device for linear slide guide, the cover plate is made up of polymer elastomer and connected to end cover to be installed at both sides of a sliding block, the above structure thus formed can effectively absorb the impact force generated when the rolling component makes its directional turning at the buffer part.

A lubrication device for linear slide guide able to achieve the above-mentioned invention purpose, comprising of:

an end cover having a dented and downward placement space installed at its inner side and two shape-correlated extension parts are further formed above the end cover, moreover, an upward U-turning part and a downward U-turning part are formed on the extension part, the upward U-turning part is connected to the downward U-turning part by lubricant channel, furthermore, lubricant hole is installed on the end cover and connected to placement space;

a cover plate having a flowing space installed at its inner side, the flowing space form a continuous flowing channel with the lubricant channel of the end cover, and its two sides form a buffer part which further forms a correlating shape to the upper U-turning part and the lower U-turning part on both sides of the end cover, at the appropriate location on the buffer part correlating to the upper U-turning part and lower U-turning part are further penetrated and installed with lubricant hole to be connected to the flowing channel;

the cover plate is closely placed and installed in the placement space of the end cover so that the buffer part of the cover plate is able to be placed in the upper U-turning part and lower U-turning part at the two sides of the end cover in order to form a complete body, through this way, the lubricant channel of the end cover and the flowing space of the cover plate can form a continuous flowing channel with sealing function, after the lubricant enters the lubricant hole, the continuous and well-sealed flowing channel can evenly distribute the lubricant without leaking it out and the lubricant can flow directly into lubricant hole through the flowing channel to lubricate the rolling component and sliding rail.

### BRIEF DESCRIPTION OF THE DRAWINGS

The drawings disclose an illustrative embodiment of the present invention, which serves to exemplify the various advantages and objects hereof, and are as follows:

FIG. 1 is a three-dimensional decomposition illustration of left rear side of the lubrication device for a linear slide guide of the current invention;

FIG. 2 is a three-dimensional decomposition illustration of right front side of the lubrication device for a linear slide guide;

FIG. 3 is a three-dimensional decomposition illustration of right rear side of the lubrication device for a linear slide guide;

FIG. 4 is a front view diagram of the end cover of the current invention;

FIG. 5 is a front view diagram of the cover plate of the current invention;

FIG. 6 shows a continuous flowing channel formed by an assembly of a lubricant channel of an end cover and a flowing space of a cover plate;

FIG. 7 is the front view of the prior art lubrication device for linear slide guide;

FIG. 8 is the partial cross-sectional view of the lubrication device of the second type of the prior art linear slide guide; and

FIG. 9 is the cross-sectional view of the lubrication device of the third type of the prior art linear slide guide.

### DETAILED DESCRIPTION OF THE PREFERRED EMBODIMENT

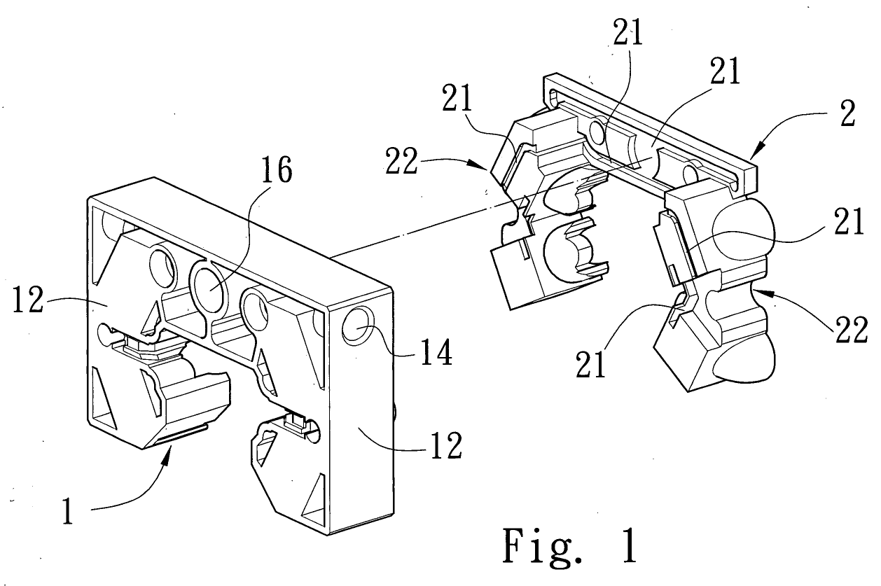

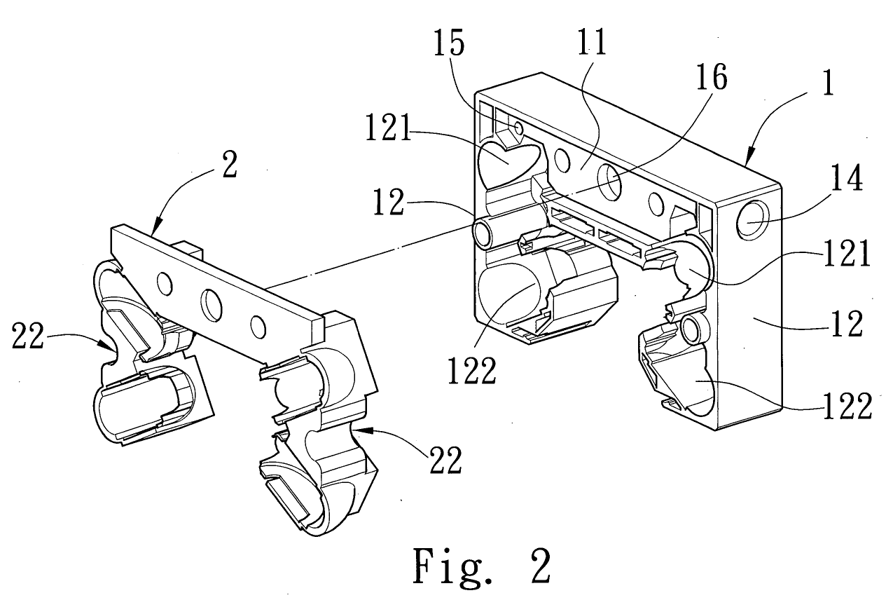

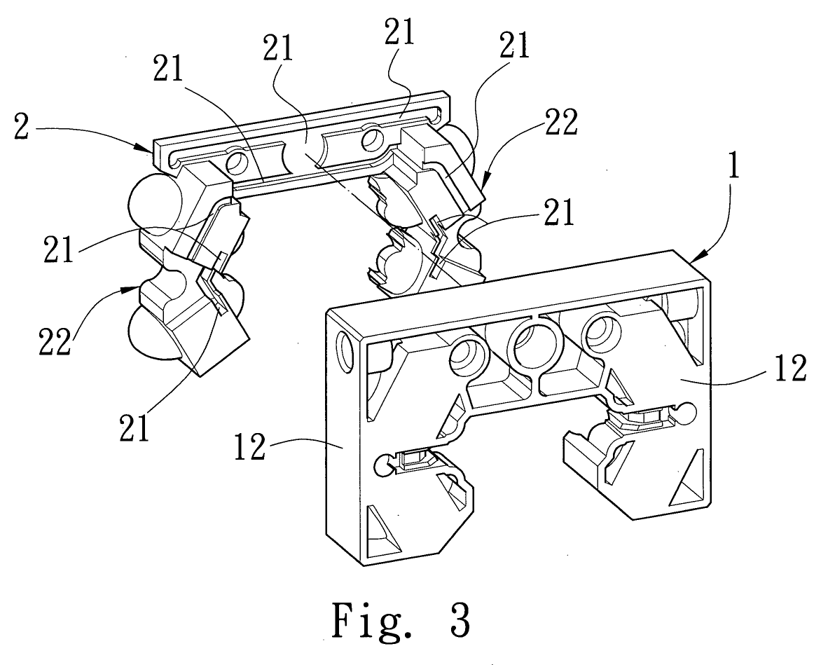

Please refer to FIG. 1 through FIG. 5, the lubrication device for linear slide guide provided in the current invention mainly comprising of:

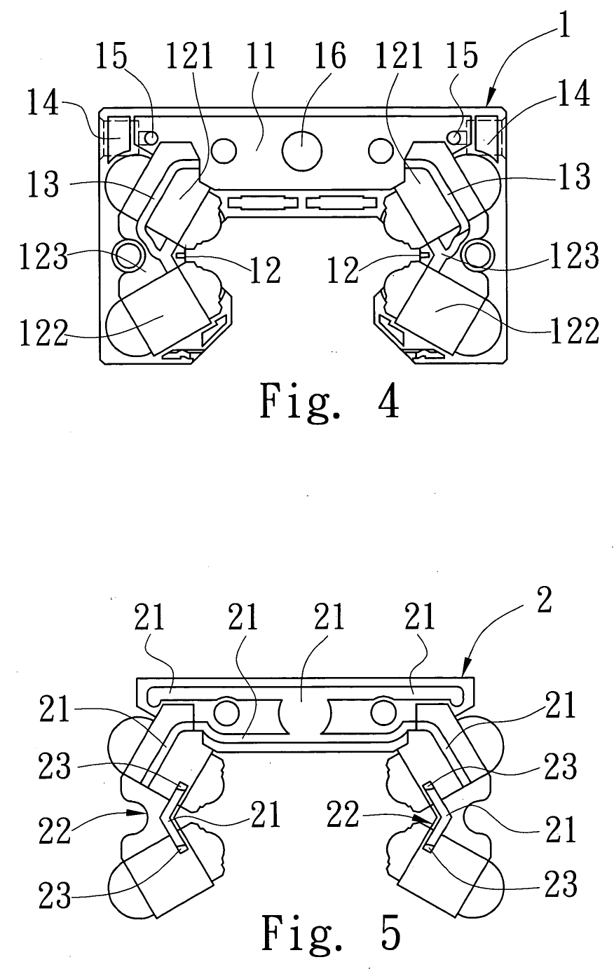

an end cover 1, the end cover 1 can be made up of metal or resin, its inner side is installed with a downward and dented placement space 11, the placement space 11 is opened with a central lubricant hole 16, meanwhile, two shape-correlating extension parts 12 are formed above end cover 1, and an upward U-turning part 121 and a downward U-turning part 122 are formed on the extension part 12, the upward U-turning part 121 is connected to downward U-turning part 122 through lubricant channel, moreover, correlating side lubricant holes 14 are installed on the external two sides of the end cover 1, moreover, the side lubricant hole is connected to the placement space 11 through a round hole 15, this is as shown in FIG. 4;

a cover plate 2, the cover plate can be made up of polymer elastomer with hardness in the range Shore 40A˜Shore 82D, its inner side is installed with a flowing space 21, the flowing space 21 can form with the lubricant channel 13 of end cover 1 a continuous flowing channel 3 having sealing function, its two sides extends and forms a buffer part 22 correlating in shape to the upward U-turning part 121 and downward U-turning part 122 on both sides of end cover 1, the buffer part 22 is further installed and penetrated with lubricant hole 23 at appropriate locations correlating to upward U-turning part 121 and downward U-turning part 122 so that it can be connected to flowing channel 3, this is as shown in FIG. 5.

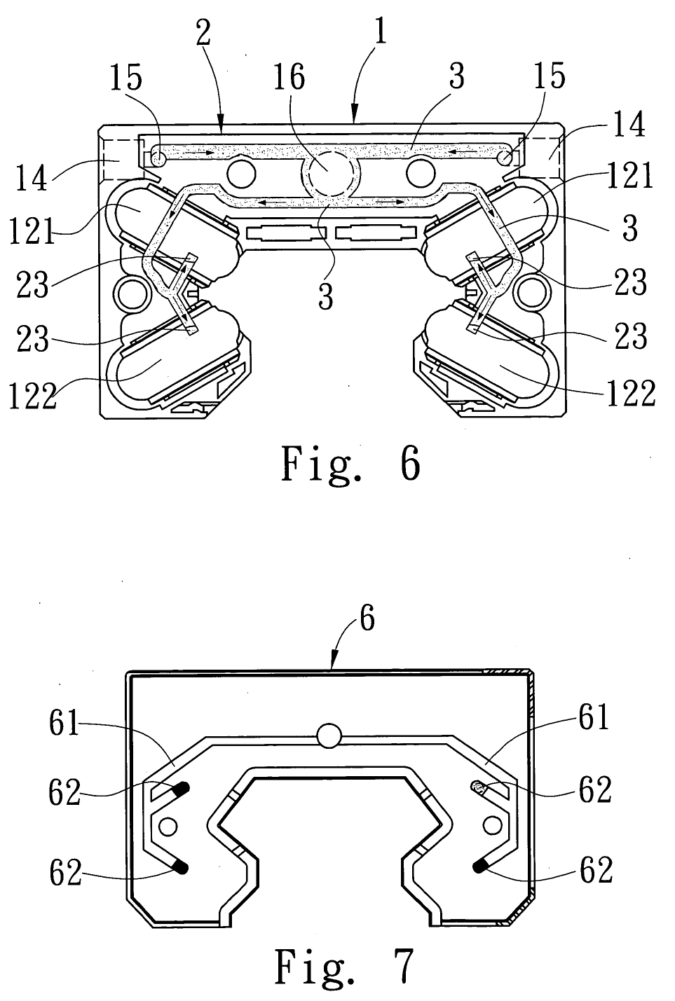

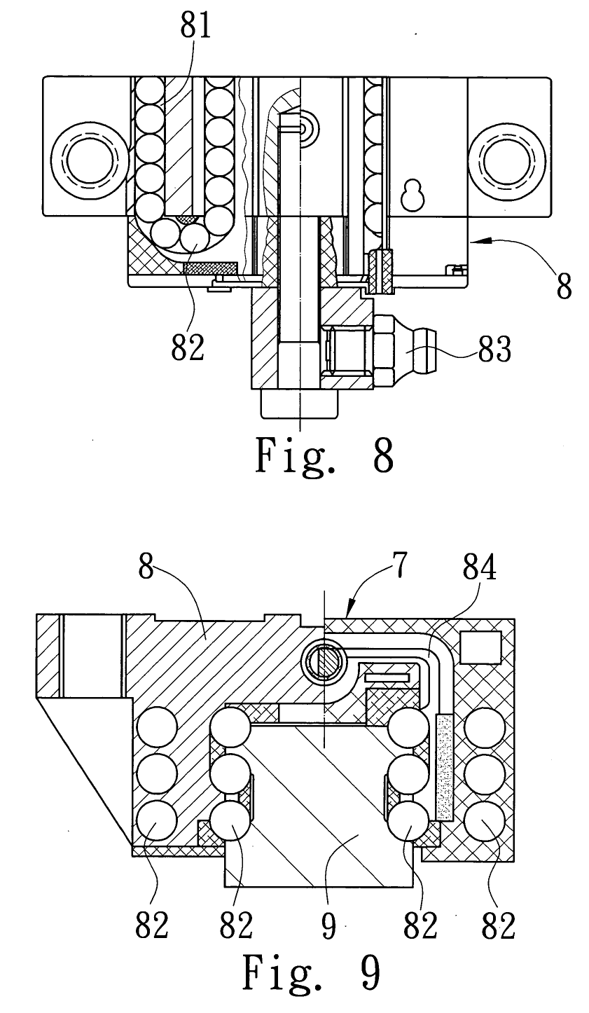

For detailed descriptions about this invention, please refer to FIG. 6 again. The cover plate 2 of the current invention closely and completely installed in the placement space 11 of the end cover 1, moreover, the buffer part 22 of the cover plate 2 can thus be completely placed in the upward U-turning part 121 and downward U-turning part 122 on both sides of end cover 1 in order to form a complete body with end cover 1 and thus generate a sealing function.

Through such method, the lubricant channel 13 of end cover 1 and the flowing space 21 of cover plate 2 can thus form a continuous flowing channel 3 having sealing function, the flowing channel 3 will, together with flowing space 21, continuously extend to the central location 123 of the upward U-turning part 121 and downward U-turning part 122, therefore, when the lubricant enters from side lubricant hole 14 or central lubricant hole 16, it can be concentrated in the flowing space 21, then it flows to the central location 123 of upward U-turning part 121 and downward U-turning part 122 through continuous flowing channel 3, at here the flowing channel 3 is further divided into two streams of symmetrical and reverse direction to be connected to the lubricant hole 23 which is installed and penetrated at the buffer part 22, its lubricant can distribute evenly and flow into directly through the connected lubricant hole 23 in order to lubricate the rolling component (not displayed in the figure) and sliding rail (not displayed in the figure), as shown in FIG. 6.

Moreover, since the design at upward U-turning part 121 of the lubricant channel 13 of end cover 1 and flowing space 21 of cover plate 2 adopts a symmetrical way, therefore, it can allow the lubricant to enter through the side lubricant hole 14 and pass through a round hole 15 to finally enter the placement space 11, or enter the placement space 11 through a central lubricant hole 16, the lubricant can thus flows smoothly along the flowing space 21, meanwhile, the sealed flowing channel 3 formed by the end cover 1 and cover plate 2 is connected to the flowing space 21 too, therefore, when lubricant enters flowing channel 3, it can distribute itself evenly on each upward U-turning part 121 and downward U-turning part 122 with steady speed, then it flows into the rolling component and the sliding rail through the lubricant nipple 23 of buffer part 22 of cover plate 2.

For a more detailed description of the current invention, please refer to FIG. 1 to FIG. 3, in the current invention, the material used in cover plate 2 has a hardness smaller than that of the end cover 1, the end cover 1 is made up of resin, but the cover plate 2 is made up of thermoplastic and thermoset rubber, in the later description of the current invention, thermoplastic will be used as an example, therefore, when cover plate 2 made up of rubber and end cover 1 made up of metal or resin are assembled together, the cover plate 2 can have a shock reducing and sealing effect due to its rubber material property and be closely and completely installed in the placement space 11 of end cover 1, the upward U-turning part 121 and downward U-turning part 122, etc., so that a complete body can be formed, furthermore, the flowing space 21 of the cover plate 2 can be sealed in the end cover 1, moreover, the sealed channel 13 can prevent the entered lubricant to leak away through the gap between the end cover 1 and cover plate 2 and the later contamination; the main reason that rubber material is used for the cover plate 2 is that it has superior wear-resistant, shock-reducing and sealing functions, etc., therefore, when the end cover 1 and cover plate 2 after assembly is installed on two end surfaces of the sliding block and when all the rolling components inside the sliding block perform directional U-turning at the buffer part 22, the impact force generated by the rolling component can be absorbed effectively by the cover plate 2, meanwhile, the shock generated by the rolling component during its directional U-turning can be effectively reduced, moreover, since the impact noise due to the impact force is reduced, the moving sound due to the straight line reciprocal movement of the sliding block can be relatively reduced.

When the lubrication device for linear slide guide disclosed by this invention is compared to the above-mentioned patents and prior arts, it has the following advantages:

(1) The cover plate is made up of polymer elastomer, and end cover is made up of a material of higher hardness than that of cover plate, therefore, the cover plate can be installed closely at the end cover in order to effectively enhance the sealing effect between the flowing space and the flowing channel.

(2) The flowing space of the cover plate and all the lubricant channels of the end cover can form in symmetrical way with all the sections of upward U-turning part, therefore, when lubricant enters the placement space, it can be distributed evenly and steadily onto the upward U-turning part and downward U-turning part.

(3) Since the cover plate is made up of polymer elastomer, therefore, when all the rolling components perform their directional U-turning at the buffer part, respectively, the impact forces generated can be effectively absorbed by the cover plate, meanwhile, the impact noise due to impact noise becomes thus, relatively small.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A lubrication device for linear slide guide, comprising of:
an end cover having a downward and dented placement space installed at its inner side, meanwhile, two correlating-shape extension parts are formed above the end cover, moreover, an upward U-turning part and a downward U-turning part are formed on the extension part, the upward U-turning part is connected to the downward U-turning part by a lubricant channel, and lubricant hole is installed on the end cover which is further connected to placement space;
a cover plate having a flowing space at its inner side, the flowing space can form a continuous flowing channel with the lubricant channel of the end cover, moreover, both sides of it extend to form a buffer part to be correlated in shape to the upward U-turning part and downward U-turning part on both sides of the end cover, furthermore, at the appropriate locations of the buffer part correlating to the upward U-turning part and downward U-turning part are installed and penetrated with lubricant hole to be connected to the flowing channel;
furthermore, the cover plate is installed closely on the placement space of the end cover, and the buffer part of the cover plate can be placed on the upward U-turning part and downward U-turning part on both sides of the end cover in order to form a complete body, through this way, the lubricant channel of the end cover and the flowing space of the cover plate can form together a continuous flowing channel having sealing function, after the lubricant enters the lubricant hole, the continuous and well-sealed flowing channel can evenly distribute the lubricant without leaking it out and the lubricant can flow directly into lubricant hole through the flowing channel to lubricate the rolling component and sliding rail.

2. The lubrication device for linear slide guide of claim 1 wherein the cover plate has a smaller material hardness than that of the end cover.

3. The lubrication device for linear slide guide of claim 1 wherein the over plate is made up of polymer elastomer.

4. The lubrication device for linear slide guide of claim 1, 2 or 3 wherein the cover plate has a hardness in the range Shore 40A˜Shore 82D.

5. The lubrication device for linear slide guide of claim 1 wherein a central lubricant hole is opened and installed at the placement space of the end cover.

6. The lubrication device for linear slide guide of claim 3 wherein the polymer elastomer is a thermoset rubber.

7. The lubrication device for linear slide guide of claim 3 wherein the polymer elastomer is a thermoplastic
